(19) United States
(12) Patent Application Publication
(10) Pub. No.: US 2013/0215614 A1
(43) Pub. Date: Aug. 22, 2013

(54) MODULAR LIGHT EMITTING DIODE SYSTEMS AND DEVICES

(71) Applicant: Jascha Gulden, Port Townsend, WA (US)

(72) Inventor: Jascha Gulden, Port Townsend, WA (US)

(73) Assignee: RELIANCE LABORATORIES, LLC, Port Townsend, WA (US)

(21) Appl. No.: 13/470,320

(22) Filed: May 13, 2012

Related U.S. Application Data
(60) Provisional application No. 61/485,869, filed on May 13, 2011.

(51) Int. Cl. F21V 21/00; F21V 19/00; F21V 31/00

(52) U.S. Cl. CPC F21V 21/00; F21V 31/00; F21V 19/003
USPC 362/249.02; 362/382; 29/825

(57) ABSTRACT

The present invention relates to devices, systems and methods comprising light emitting diodes. Some embodiments include a module comprising a light emitting diode, an electrical circuit, and a connector. In various embodiments a module provides an extensible conductive circuit containing light emitting diodes and/or other electric circuitry. Some embodiments comprise a method for constructing a luminary from modules comprising a light emitting diode.

### RELATED APPLICATION

This application claims priority to U.S. Provisional Application Ser. No. 61/485,869, filed on May 13, 2011, the entirety of which is hereby incorporated by reference.

### FIELD OF THE INVENTION

The present invention relates to devices, systems and methods comprising light emitting diodes. Some embodiments include a module comprising a light emitting diode, an electrical circuit, and a connector. In various embodiments a module provides an extensible conductive circuit containing light emitting diodes and/or other electric circuitry. Some embodiments comprise a method for constructing a luminary from modules comprising a light emitting diode.

### BACKGROUND

Traditional light fixture assemblies have used incandescent bulbs and fluorescent tubes. Fluorescent tubes are generally more energy-efficient than incandescent bulbs; while incandescent bulbs have traditionally produced a more pleasing light (e.g. less flicker, preferable color). For these reasons, incandescent bulbs have generally been preferred in residential applications, while fluorescent tubes were used predominately in commercial settings.

In recent years, however, energy costs have increased, while advances in lighting technology have made fluorescent tubes more cost effective. Additionally, advances in fluorescent tube technology have resolved some of the flicker and spectrum concerns. These factors have created a trend toward using compact fluorescent tubes in homes. New compact fluorescent lamps (CFLs) with the same shape and form-factor of incandescent bulbs have begun to replace incandescent bulbs in the marketplace. The new CFLs are generally more expensive than incandescent bulbs, but promise a superior lifespan. Like incandescent bulbs, fluorescent tubes and bulbs are made of glass. Moreover, most fluorescent tubes contain mercury and/or other toxic substances, and create ecological and health concerns.

Generally, light emitting diodes (LEDs) have a smaller size and longer lifespan than other light sources while exhibiting superior efficiency in converting electrical energy into light. LEDs are much more compact than incandescent bulbs or fluorescent tubes, are substantially more rugged, and have a number of other technical advantages. Even so, LEDs have been used mainly in electronic devices, and more rarely as primary lighting devices. Some manufacturers have produced LED-bulbs in the same vein as the CFLs described above, however these products are much more expensive than competing products and have had poor market penetration.

### SUMMARY

In various embodiments a module (otherwise referred to as a “component”) provides an extensible conductive circuit containing light emitting diodes and/or other electric circuitry. Some embodiments comprise a method for constructing a luminary from modules comprising a light emitting diode. In some embodiments, a modular linear LED (Light Emitting Diode) lighting system (MLLLS) is an LED-based luminaire comprises a plurality of independent modules each module comprises an electrical circuit or conductive path disposed such that the continuity of the modular linear LED lighting may be extended. The modules are easily joined to create more complex circuits. Modules can be configured so as to change the physical path and/or angle in two or three dimensions. The linear LED lighting system is intended to allow a large number of possible system configurations.

### BRIEF DESCRIPTION OF THE DRAWINGS

FIG. 1. depicts a portion of a MLLLS.

FIG. 2 depicts an interface between a flexible wire and a MLLLS.

FIG. 3 depicts a detailed view of an MLLLS component.

FIG. 4 depicts a detailed view of an MLLLS component.

FIG. 5 depicts a detailed view of an MLLLS component.

FIG. 6 depicts a detailed view of an MLLLS component.

FIG. 7 depicts the interface of FIG. 2.

FIG. 8 depicts the component of FIG. 3.

FIG. 9 depicts the component of FIG. 4.

FIG. 10 depicts the component of FIG. 5.

FIG. 11 depicts the component of FIG. 6.

### DETAILED DESCRIPTION

In various embodiments a module provides an extensible conductive circuit containing light emitting diodes and/or other electric circuitry. Some embodiments comprise a method for constructing a luminary from modules comprising a light emitting diode.

Previous lighting systems have generally relied on a small number of relatively bright light sources, disposed in centralized locations so as to provide light to the entire room. This model stems from the systems' support structure requirements (e.g. fixtures, ballasts). Prior attempts to create LED-based lighting systems, including LED bulbs and other small LED arrays have attempted to rely on the same model.

It is presently disclosed that the prior attempts to use LEDs in the same modality as prior luminaries have undermined the potential of LED-based lighting systems. Attempting to condense a bright array of LEDs into a bulb or similar point source of light reduces the lighting potential of each LED and generates large amounts of heat, requiring the use of heat sinks or other techniques. For these reasons, LED-based lighting systems have lagged behind fluorescent and incandescent systems, even though LED-based systems are more rugged, last longer, and provide more constant lighting characteristics than either fluorescent or incandescent.

In certain embodiments discussed herein, a MLLLS is shown to provide distinct advantages over previously-known systems. In certain embodiments, such MLLLS systems avoid the disadvantages of previous lighting systems, while exploiting the advantages of LED based systems by moving away from the centralized fixture model.

For example, in some embodiments a plurality of independent modules, each containing an electric circuit and/or one or more LEDs provides for an extensible and configurable conductive path and lighting arrangement. Advantageously, such embodiments allow for a user to produce an individualized lighting arrangement tailored to the shape and optical properties of the space to be illuminated, as well as to the luminary properties of the particular LEDs used.

In some embodiments, independent modules are configured so as to allow the construction of conductive paths in one dimension. In such embodiments, the connectors on or between the modules are disposed so as to provide for only linear connection. In other embodiments, connectors are provided to allow conductive paths to be created in two or three dimensions. In such embodiments, connectors on or between the modules are disposed to allow for orthogonal or angled connections between the modules to create a path through two or three spatial dimensions. In some embodiments, connectors or modules will be provided to allow for a combination of linear and angled connections, so as to allow for the creation of arbitrary configurations in 2-space or 3-space.

Further embodiments allow for modules containing electronic components other than LEDs to be introduced to the conductive path. In some embodiments, such other-than-LED modules could modulate the lighting cycles or properties of the LEDs on the same or other modules (e.g. dimmers, motion-sensor-based illumination, sound-initiated illumination, blinkers, or a multitude of other possibilities that will be apparent to persons of ordinary skill in the art). In other embodiments, such other-than-LED modules could provide other desirable features as part of the lighting path (e.g. buzzers, alarms, piezoelectric devices, electromagnets, or other components that will be apparent to persons of ordinary skill in the art).

The following descriptions describe in detail an example embodiment of a MLLLS system as depicted in the attached drawings. The particular arrangement and characteristics of the MLLLS system and its components described below are illustrative; however, it will be readily apparent to a person of ordinary skill in the art, upon reviewing this disclosure, that a wide variety of components and systems can be created within the scope and spirit of this disclosure:

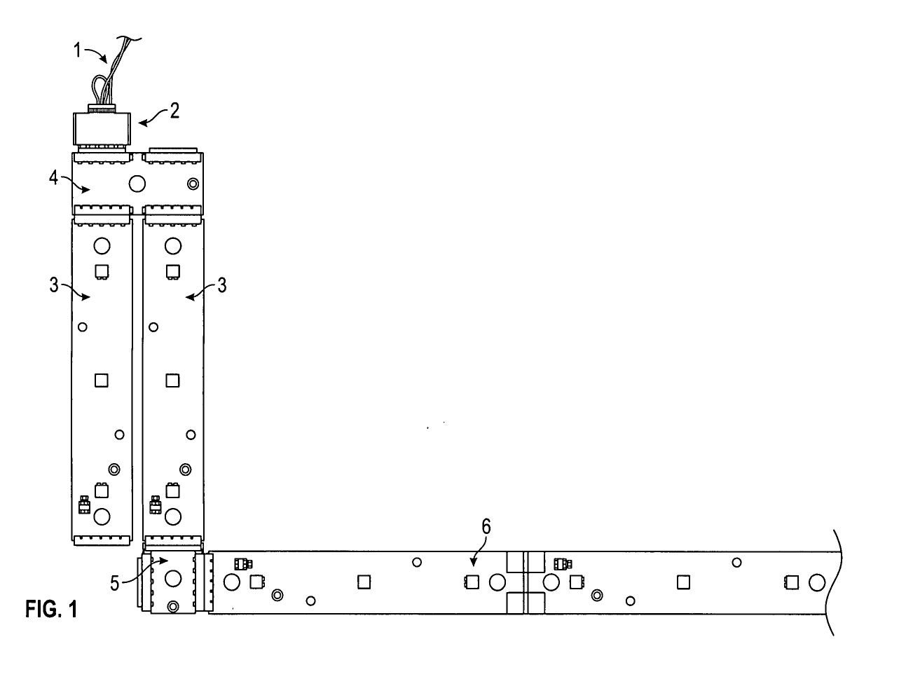

FIG. 1. depicts a portion of a MLLLS assembled into a 2-dimensional array. A flexible conductive wire 1 is connected to a MLLLS initiator 2. The initiator 2 connects to an assembled array of MLLLS components 3, 4, 5, 6. Each of the MLLLS components depicted in this example embodiment is fabricated as a printed circuit board (PCB), onto which various conductive traces and electronic components have been disposed.

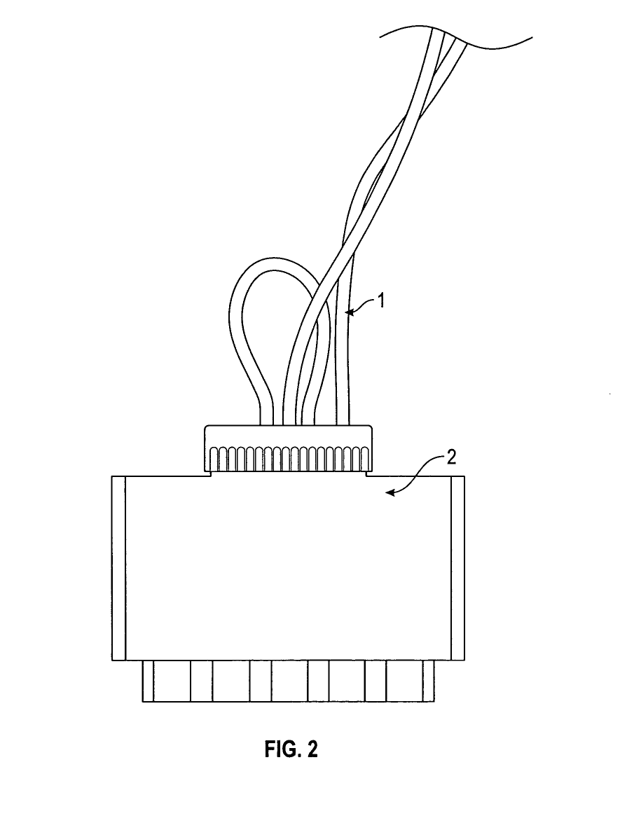

FIG. 2 depicts an interface between a flexible wire and a MLLLS compatible with certain embodiments describe herein. The flexible conductive wire 1 depicted is an insulated wire frequently used in electrical systems. The flexible conductive wire 1 is electrically and mechanically connected to a MLLLS initiator 2, which facilitates electrical transition between the flexible conductive wire 1 and a MLLLS.

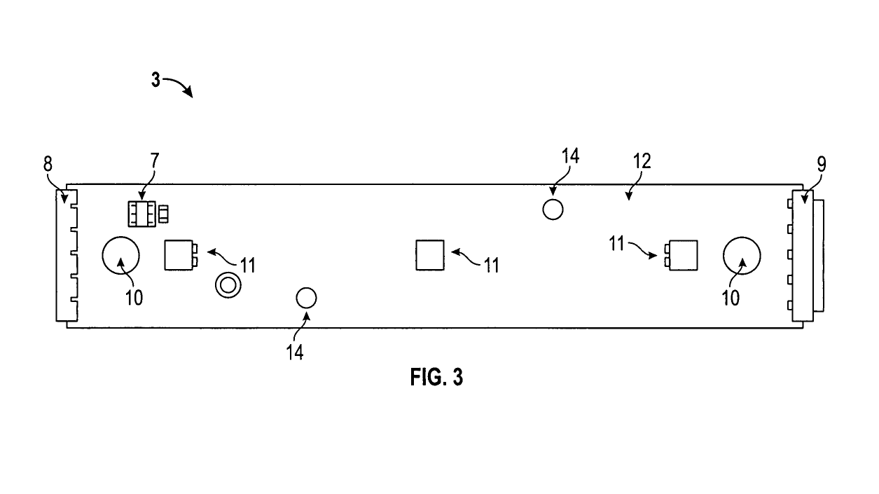

FIG. 3. depicts a detailed view of an MLLLS component 3, depicted in the array of FIG. 1. The MLLLS component depicted comprises a female co-planar friction contact connector 8, which is configured to be connectable to a male friction contact, such as in the configurations depicted in FIG. 1. The MLLLS component depicted further comprises a male co-planar friction contact 9, configured to mate with a female connector on a separate module. The friction connector is disposed upon a rigid or semi-rigid non-conductive substrate 12. The substrate comprises a first side and a second side, in which the first side comprises a first region and a second region. The substrate further comprises a plurality of conductive contact pads on the first region, a first plurality of electrically conductive plates on the second region, optionally, LEDs 11 are arranged in a circuit on the second region, a plurality of conductive circuit traces formed on the first side that communicate selectively with the plurality of conductive contact pads and the LEDs, and a plurality of electrical components, including regulation circuitry 7, are disposed on the plurality of contact pads. The MLLLS component depicted further comprises mounting holes 10, which are defined by an absence of substrate material, and are located so as to allow mounting of the MLLLS component to a surface (e.g. a wall, ceiling, or bulkhead). The MLLLS component depicted further comprises optional accessory mounting holes 14, defined by an absence of substrate, which allow for the connection of additional optional components (e.g. diffusers, lenses, focusers, reflectors, or other optical devices).

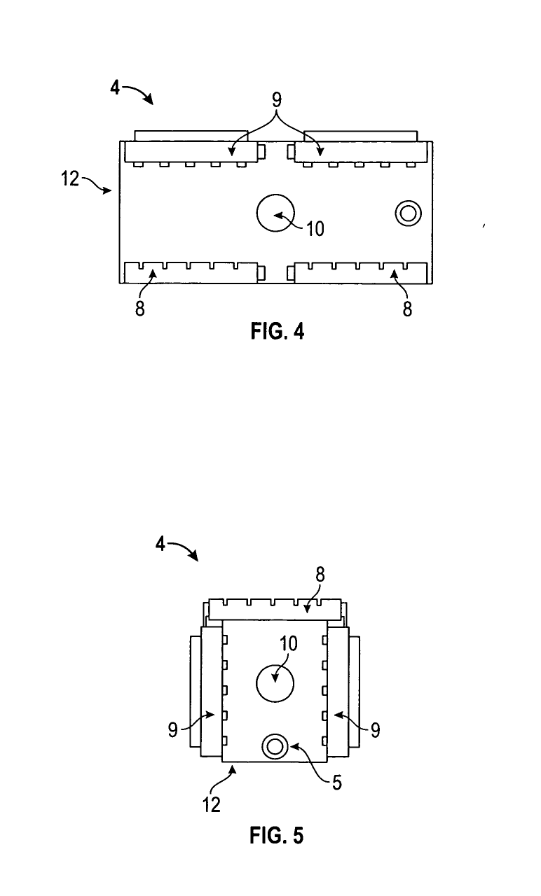

FIG. 4. depicts a detailed view of an MLLLS component 4. The component depicted comprises two male co-planar friction contacts 9, two female co-planar friction contacts 8, a substrate 12, and a mounting hole 10. The component depicted does not comprise any LEDs, but may be used as a splitter to create complex MLLLS arrays, such as the one shown in FIG. 1.

FIG. 5 depicts a detailed view of an MLLLS component 5. The component depicted comprises two male co-planar friction contacts 9, one female co-planar friction contact 8, a substrate 12, and a mounting hole 10. The component depicted does not comprise any LEDs, but may be used as a splitter to create complex MLLLS arrays, such as the one shown in FIG. 1.

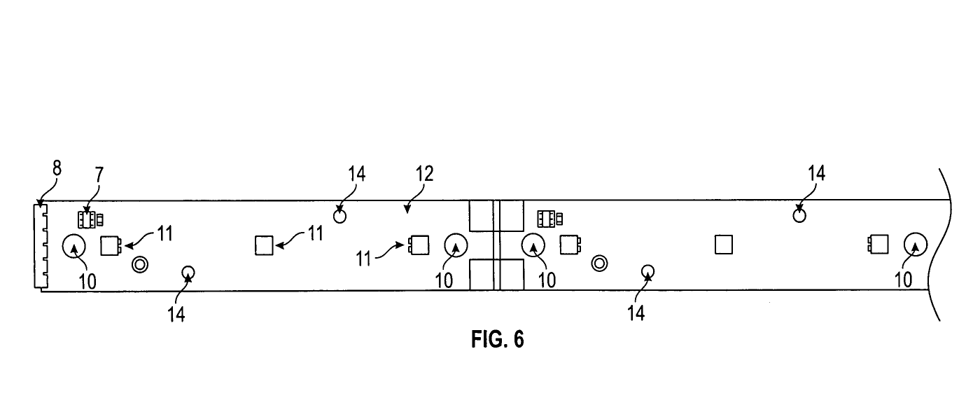

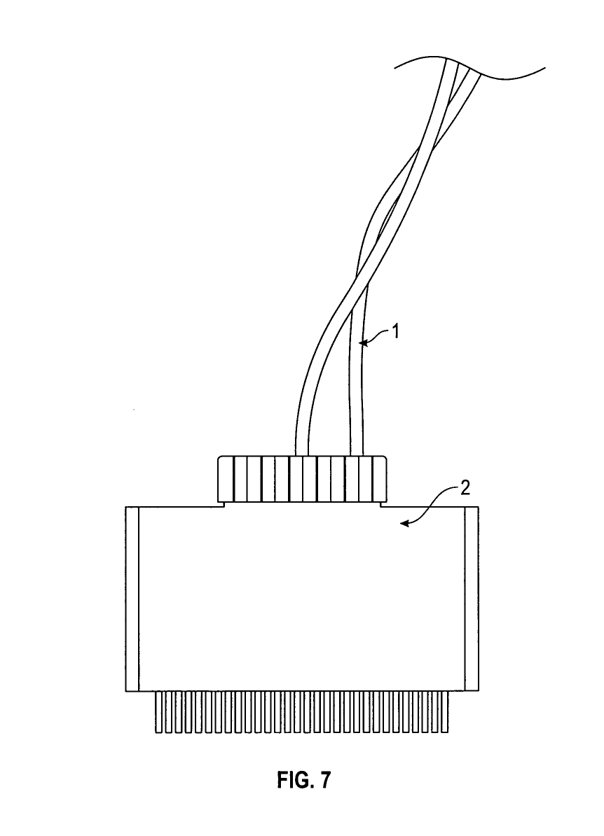

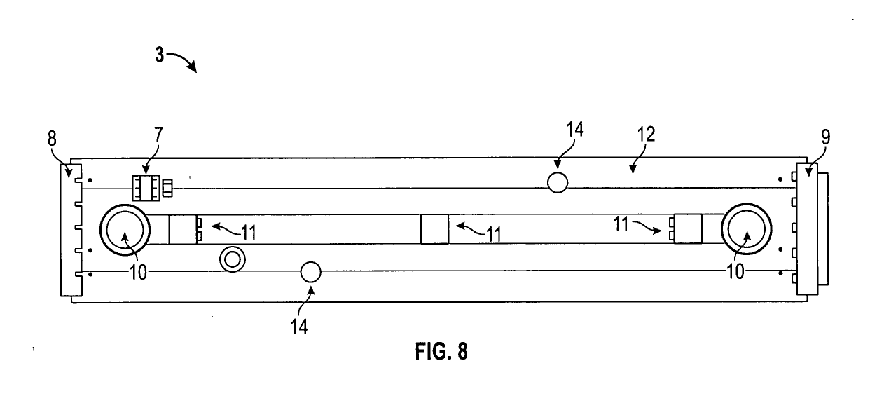

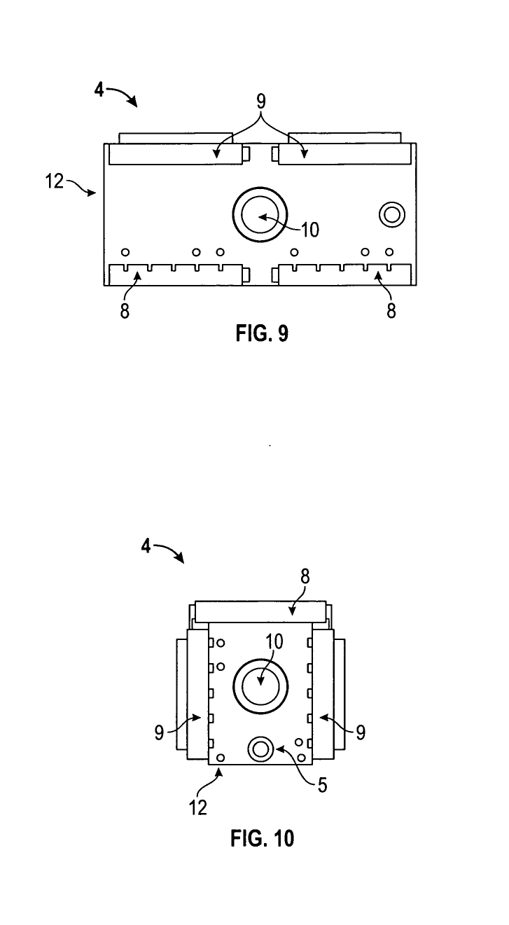

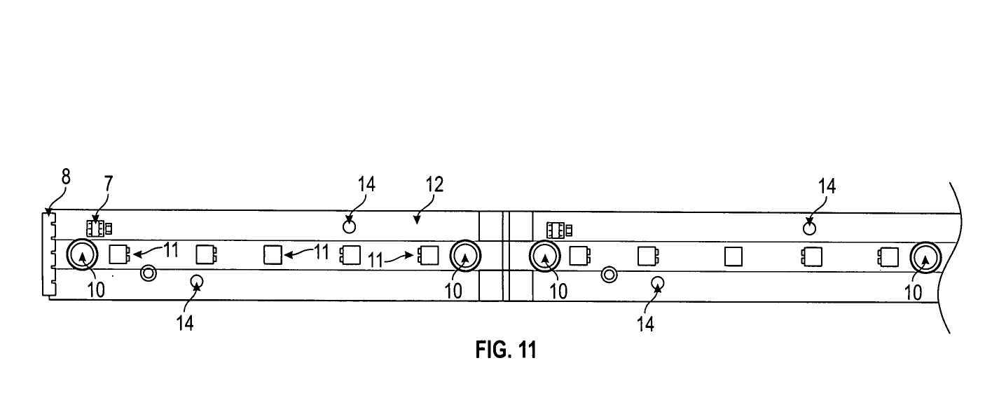

FIG. 6 depicts a detailed view of an MLLLS component 6. The component depicted contains two modules of the type depicted in FIG. 3, which have been permanently connected during the manufacturing process, In various embodiments, pluralities of basic MLLLS circuits may be joined in various arrangements during the manufacturing phase to reduce the number of independent components required for a particular application.

In one embodiment, a MLLLS system comprises 3.5 mm warm-white LEDs, configured to produce 28 lumens each. In another embodiment, modules can be formed at lengths of less than an inch to 30 feet. In some embodiments a 16 inch module can be configured with LEDs to produce 336 lumens. In some embodiments, modules can be formed on PCBs 0.75 inches in width, or at any other suitable size. In some embodiments, modules can be created at 0.25 inches thick, or at any other suitable size. In some embodiments modules can be formed of a tough FR4 fiberglass core sheeted in double thick copper and then gold plated to resist corrosion. In some embodiments, the modules can be further upgraded to resist outdoor and marine environments. In some embodiments, an in-line dimmer can be operated to change the total brightness of the MLLLS system or the brightness of one or more specific LEDs.

In certain embodiments, an LED module comprises one or more LED circuits in electronic communication with a conductive pathway, wherein the LED circuit comprises a plurality of LEDs arranged in series topology in a circuit that includes an LED regulation IC (integrated circuit) and one or more associated components, the LED circuit limits the current and voltage delivered to the LEDs. Moreover, in certain embodiments, the LED circuit is configured to interpret a dimming signal sent from a dimming module to dim the LEDs. In some embodiments, the dimming is accomplished by adjusting a PWM (pulse width modulation) duration according to a desired or selected dimming setting. In certain embodiments a plurality of series topology LED circuits are assembled in parallel topology forming a series parallel circuit topology.

It will be understood by a person of ordinary skill in the art that the above examples are illustrative of a broad range of devices and methods within the spirit and scope of the present disclosure. For example, in some embodiments substrates other than PCBs provide for similar functionality, while also providing varying performance characteristics as known in the art. In various embodiments connectors various types of mechanical connectors are used in place of the friction connectors described above, allowing for a range of operations. While various embodiments disclosed herein depict mounting holes in the substrate, other mounting options are possible as will be apparent to a person of ordinary skill in the art. In various embodiments, joists, support frames, adhesive pads, hook and loop connectors, glues, tapes, and other connectors are used alone or in conjunction. In some embodiments, MLLLS circuits are composed of modules embedded in, or attached to other materials.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably coupleable”, to each other to achieve the desired functionality. Specific examples of operably coupleable include but are not limited to physically mateable and/or physically interacting components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Although embodiments of the invention discussed and disclosed in the context of certain referred embodiments and examples, it will be understood by those skilled in the art that the present embodiments extend beyond the specifically disclosed embodiments to other alternative embodiments and/or uses of the embodiments and obvious modifications and equivalents thereof. In addition, while several variations of the embodiments have been shown and described in detail, other modifications, which are within the scope of these embodiments, will be readily apparent to those of skill in the art based upon this disclosure. It is also contemplated that various combination or sub- combinations of the specific features and aspects of the embodiments may be made and still fall within the scope of the inventions. It should be understood that various features and aspects of the disclosed embodiments can be combined with or substituted for one another in order to form varying modes of the disclosed embodiments. Thus, it is intended that the scope of at least some of the present technology and embodiments herein disclosed should not be limited by the particular disclosed embodiments described above.

What is claimed is:

1. A module comprising:
a substrate comprising a conductive circuit;
the conductive circuit comprising a conductive pathway and regulation circuitry;
a module connector, the module connector operably coupled to the conductive circuit; and
a light emitting diode, the diode operably coupled to the conductive circuit.

2. The module of claim 1, wherein the module connector comprises a rigid connector.

3. The module of claim 2, wherein the module connector is configured to operably connect to a second module.

4. The module of claim 3, wherein the substrate further comprises mounting holes.

5. The module of claim 3, wherein the substrate further comprises a waterproof outer layer.

6. The module of claim 3, wherein the module connector is further configured to operably connect the second module perpendicular to the first module.

7. The module of claim 3, wherein the substrate comprises a rigid material.

8. The module of claim 7, wherein the substrate comprises a printed circuit board.

9. The module of claim 7, wherein the module is configured to produce at least 300 lumens of light.

10. The module of claim 7, wherein the module further comprises a fiberglass core, wherein the fiberglass core is sheathed in copper, and wherein the copper is plated with gold.

11. A method for assembling a luminary comprising:
obtaining a first module and a second module, the first module and the second module each comprising:
a substrate comprising a conductive circuit;
a module connector, the module connector operably coupled to the conductive circuit;
a light emitting diode, the diode operably coupled to the conductive circuit; and
connecting the module connector of the first module to the module connector of the second module.

12. The method of claim 11, further comprising driving a fastener through a mounting hole on the first module and into a mounting surface.

13. The method of claim 12, further comprising adjusting the brightness of the luminary by operating a dimmer.

14. The method of claim 13, further comprising installing the connected modules in a room to be illuminated.

15. A luminary comprising:
a plurality of modules, each module comprising:
a rigid substrate comprising a conductive circuit;
a module connector, the module connector operably coupled to the conductive circuit;
one or more of the modules further comprising a light emitting diode, the diode operably coupled to the conductive circuit;
one or more of the modules further comprising a regulation circuit, the regulation circuit operably coupled to the conductive circuit; and
each of the plurality of modules connected by their respective module connectors to at least one other module.

16. The luminary of claim 15, wherein each of the plurality of modules is electrically coupled with each other of the plurality of modules through its conductive circuit.

17. The luminary of claim 16, further comprising a power source, the power source comprising a module connector, wherein the module connector of the power source is operably connected to the module connector of one of the plurality of modules.

18. The luminary of claim 16, wherein at least one of the plurality of modules further comprises a mounting hole.

19. The luminary of claim 18, wherein the plurality of modules are mounted to a mounting surface by at least one fastener passing through at least one mounting hole in at least one of the plurality of modules.RELIANCE

20. The luminary of claim 18, wherein at least one of the plurality of modules comprises at least three module connectors, at least one of the at least three module connectors being substantially perpendicular to at least one other of the at least three module connectors.

21. The luminary of claim 18, wherein at least one of the plurality of modules comprises two parallel pairs of module connectors.

22. The luminary of claim 19, wherein fewer than all of the plurality of modules are mounted to a mounting surface by means of fasteners, and wherein the remaining of the plurality of modules are held substantially against the mounting surface by at least one module connector of at least one adjoining module.

23. The luminary of claim 22, wherein at least one of the plurality of modules is configured to produce at least 300 lumens of light.

24. The luminary of claim 23, wherein the rigid substrate further comprises a fiberglass core, a copper sheath around the fiberglass core, and a gold plating on the copper sheath.

25. The luminary of claim 24, further comprising a dimmer device, wherein the dimmer device is electrically connected to the conductive circuits of the plurality of modules, and wherein the dimmer device is configured to modulate the brightness of the luminary.
